(19) United States
(12) Patent Application Publication
(10) Pub. No.: US 2009/0033907 A1
(43) Pub. Date: Feb. 5, 2009

(54) DEVICES AND METHODS FOR DECREASING RESIDUAL CHUCKING FORCES

(75) Inventors: Douglas C. Watson, Campbell, CA (US); Christopher S. Margeson, Mountain View, CA (US); Alton H. Phillips, East Palo Alto, CA (US); Hiromitsu Yoshimoto, Saitama (JP); Noriya Kato, Gunma (JP)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 12/168,726

(22) Filed: Jul. 7, 2008

Related U.S. Application Data
(60) Provisional application No. 60/958,481, filed on Jul. 5, 2007.

(51) Int. Cl. G03B 27/62

(52) U.S. Cl. 355/75

(57) ABSTRACT

Devices and methods are disclosed for holding a reticle or analogous object, particularly a planar object. An exemplary reticle-holding device includes a reticle chuck having a reticle-holding surface on which a reticle is placed to hold the reticle. The device includes at least one ultrasonic transducer (as an exemplary vibration-inducing device) sonically coupled to the reticle to excite, whenever the ultrasonic transducer is being energized, a vibrational mode in the reticle or reticle chuck, or both. The vibration mode is sufficient to reduce an adhesion force holding the reticle to the reticle-holding surface. Sonic coupling can be by direct contact with the transducer or across a gap.

### CROSS-REFERENCE TO RELATED APPLICATION

This application claims priority from, and the benefit of, U.S. Provisional Application No. 60/958,481, filed on Jul. 5, 2007, which is incorporated herein by reference in its entirety.

### FIELD

This disclosure pertains to, inter alia, microlithography, which is a key imaging technology used in the manufacture of semiconductor micro-devices, displays, and other products having fine structure that can be fabricated by processes that include microlithographic imprinting. More specifically, the disclosure pertains to microlithography involving use of a pattern-defining reticle and to devices for holding a reticle or other planar body.

### BACKGROUND

In a typical projection-microlithography system, the pattern to be projected onto the surface of an exposure-sensitive substrate is defined by a pattern master generally termed a “reticle,” also called a “mask.” In the microlithography system the reticle is mounted on a stage that is capable of undergoing highly accurate movements as required during the lithographic exposure. While mounted on the reticle stage, the reticle is illuminated by a radiation beam (e.g., a beam of deep-ultraviolet or vacuum-ultraviolet light). As the beam propagates downstream from the reticle, the beam carries an aerial image of the illuminated pattern. This downstream beam, called a “patterned beam” or “imaging beam,” passes through a projection-optical system that conditions and shapes the patterned beam as required to form an image of the pattern on the surface of an exposure-sensitive lithographic substrate (e.g. a resist-coated semiconductor wafer or plate). For exposure, the substrate also is mounted on a respective movable stage called a “substrate stage” or “wafer stage.”

For holding the reticle (usually horizontally) during the making of lithographic exposures, the reticle stage is equipped with a “reticle chuck” mounted to a moving surface of the reticle stage. The reticle chuck holds the reticle suitably for imaging, without damaging the delicate reticle. For example, some reticle chucks hold the reticle by application of vacuum “force.” Other reticle chucks hold the reticle by electrostatic or Lorentz-force attraction. In microlithography systems in which the radiation beam is transmitted through the reticle, the reticle usually is held around its periphery (or at least along two opposing sides of the reticle) to avoid blocking light propagating to and from the reticle.

Two important measures of performance of a microlithography system are overlay and image quality. Image quality encompasses any of various parameters such as image resolution, fidelity, sharpness, contrast, and the like. “Overlay” pertains to the accuracy and precision with which a current image is placed relative to a target location for the image. For example, proper overlay requires that the current image be in registration with a previously formed, underlying structure on the substrate.

The manner in which and accuracy with which a reticle is held by a reticle chuck impacts various parameters such as image overlay and image quality on the lithographic substrate. Holding a reticle around its periphery or along two opposing sides leaves middle regions of the reticle unsupported and hence susceptible to gravitational sag. Fortunately, some of these consequences are readily modeled for behavior predictions from which offsetting corrections can be made. For example, a gravitationally sagging central region of the reticle tends to have an ideal deformed shape that is at most second-order (parabolic) about the scanning axis (y-axis) of the reticle. This deformation is consistent and predictable, and can be offset by making appropriate adjustments and/or compensations elsewhere in the system (e.g., in the projection-optical system).

As a reticle is being held on the reticle chuck, it is important to prevent movements of the reticle relative to the chuck and movements of the chuck relative to the reticle stage. Preventing such movements is especially important whenever the reticle stage is accelerating or decelerating while holding a reticle. Desirably, the reticle chuck mounted to the reticle stage produces substantial localized frictional forces at regions of contact of the reticle with the surface of the chuck. One conventional way in which these frictional forces are produced is to hold the reticle to the reticle chuck by vacuum-suction.

Whereas this technique can produce effective reticle-holding friction, the reticle may be difficult to remove from the reticle chuck, such as after vacuum-suction has been turned off (e.g., before replacing a reticle currently on the reticle stage with another reticle). This difficulty can be especially pronounced whenever the reticle and reticle chuck are both very smooth and clean, wherein the force required to separate the reticle from the reticle chuck can be very high. In some cases in which the reticle chuck is flexible and delicate, the force can fracture the chuck.

One approach for obtaining reticle-holding friction with chucks employing vacuum-suction is discussed in U.S. Pat. No. 6,480,260 to Donders et al., incorporated herein by reference. Two opposing-side (flanking) regions (relative to the y-direction, the scanning direction) of the reticle are held on the reticle stage using respective “compliant members.” The compliant members extend along respective side regions of the reticle and along respective side portions of a movable stage body of the reticle stage. One lateral side region of the compliant member is mounted to the respective side portion of the stage body and the other lateral side region of the compliant member extends in a cantilever manner from the respective side portion. Extending along the cantilevered side region of each compliant member are respective shallow vacuum spaces on which the reticle is held by evacuating the vacuum spaces. Although provided with Z-supports, the compliant members can conform, to a limited extent, to the shape of the reticle. As noted, whenever the reticle is being held on such a device, high adhesive forces can exist between the reticle and the compliant members.

Another approach is discussed in Applicant's U.S. patent application Ser. No. 11/749,706, incorporated herein by reference, in which the reticle stage has a movable support surface to which a reticle chuck is mounted. More specifically, the reticle chuck is mounted on a distal region of a “membrane,” of which a proximal region is mounted to the support surface and a distal region extends from the support surface and at least partially supports the reticle chuck in a cantilever manner. The reticle chuck includes walls and lands defining at least one vacuum cavity and multiple upward-extending pins. The lands and pins contact and support respective regions of the reticle as the vacuum cavity is evacuated to a desired vacuum level. Evacuating the vacuum cavity causes the reticle to adhere to the lands and top surfaces of the pins. Meanwhile, the membrane yields to allow the lands and pins to conform to the shape of the reticle.

From the foregoing, the stability of the reticle on the reticle stage and whether the reticle can be accurately and precisely positioned each time for exposure generally require that the reticle be held securely to the chuck without causing or allowing an uncorrectable distortion of the reticle. But, there are times when it is desirable that the reticle be removable from the chuck without damaging the reticle or chuck. I.e., when using a vacuum chuck, there are situations (e.g., in which the vacuum suction has been turned off) in which the residual force holding the reticle to the chuck (both being very smooth and clean) is too high to allow ready removal of the reticle from the chuck without significant risk of damaging the reticle chuck and/or the reticle.

Therefore, especially when using a vacuum chuck to hold a reticle or analogous planar object, there is a need for, inter alia, devices and methods for facilitating separation of the reticle from the reticle chuck without damaging, fracturing, or otherwise degrading the performance of the reticle chuck and/or the reticle.

One approach to solving this problem is discussed in U.S. patent application Ser. No. 12/062,378, filed on Apr. 3, 2008, in which alleviation of reticle-holding force is achieved pneumatically. The reticle chuck comprises a reticle-mounting surface that contacts and holds a corresponding portion of the reticle. The chuck also includes a deformable membrane coupled to at least a portion of the reticle-mounting surface such that a pneumatically mediated conformational change in the deformable membrane produces a corresponding change in the reticle-mounting surface. An example pneumatic mediation is a change of pressure in a cavity separated by the deformable membrane from a chuck cavity and defined at least in part by the deformable membrane. The pressure is changed in the cavity, relative to outside the cavity, to produce a conformational change of the deformable membrane and a corresponding change in the object-mounting surface sufficient to reduce the force with which the portion of the object is being held to the object-mounting surface.

Notwithstanding the foregoing, there are various conditions under which reticles or other delicate planar bodies are held by stages and the like. Not all reticle-holding methods are effective in all conditions. These various conditions impose a need for alternative devices and methods for reducing the residual force with which a reticle or other planar body is being held to a chuck so as to facilitate removal of the reticle from the chuck without damaging either the reticle or the chuck.

### SUMMARY

The needs summarized above are met by various aspects of the subject invention, the aspects including, but not limited to, certain devices and methods.

A first aspect is directed to devices for holding a substantially planar object. An embodiment of such a device comprises a chuck, a holding actuator, and a vibration-inducing device. The chuck can have any of various arrangements of pins (and lands, if used) that define a substantially planar object-mounting surface. E.g., the top surfaces of pins in an arrangement of pins collectively define the planar object-mounting surface. The object-mounting surface receives and holds a corresponding portion of the object. The holding actuator is coupled to the object-mounting surface and is selectively actuated and non-actuated. When actuated, the holding actuator holds the corresponding portion of the object to the object-mounting surface with a holding force. The at least one vibration-inducing device is situated relative to and sonically coupled at least to the object-mounting surface. The vibration-inducing device is selectively energized and non-energized. When energized, it excites one or more vibrational modes, at least in the object-mounting surface, sufficient to reduce the holding force.

The object-mounting surface and structures that define this surface inherently have at least one vibrational mode that can be excited. The vibration-inducing device is configured so that, when energized, it excites one or more of these vibrational modes in the object-mounting surface. Particularly desirable vibrational modes cause the object-mounting surface to bend locally in the out-of-plane direction (z-direction) and thus “peel” away from the object at least momentarily. Mode frequencies in the ultrasonic range (>20 kHz) are desirable because a vibration-inducing device producing such a vibration can impart substantial energy to the object-mounting surface at relatively small amplitude.

Hence, for many objects, due to their particular size, composition, structure, and other factors, the force-reducing vibrational mode advantageously is ultrasonic, as excited by a vibration-inducing device producing an ultrasonic wave-train. Such an ultrasonic vibration-inducing device is termed generally an “ultrasonic transducer” or “ultrasonic actuator” herein. But, it will be appreciated that, with certain objects, longer wavelengths could be used to induce the vibrational mode(s), including but not limited to audible wavelengths. Ultrasonic transducers have an advantage in that they are commercially available in various sizes, including very small sizes, and various power levels.

The vibration-inducing device can be sonically coupled to the object-mounting surface, to the object, or to both to excite the vibrational mode(s). If the vibration-inducing device is sonically coupled to the object-mounting surface, the device typically is also sonically coupled to the object by simple sonic conduction from the object-mounting surface to the object. Conversely, if the vibration-inducing device is sonically coupled to the object, the device typically is also sonically coupled to the object-mounting surface, again by simple sonic conduction. Hence, a vibrational mode excited in the object can excite a vibrational mode (similar or different) in the object-mounting surface, and vice versa.

In many instances the chuck is a vacuum chuck, which is simply a chuck that achieves adhesion of the object to the object-mounting surface by application of a vacuum. The vacuum can be applied from a suitable vacuum source (e.g., pump) to, for example, a space defined beneath the object-mounting surface. A vacuum chuck is particularly advantageous for holding a reticle during use of the reticle in making lithographic exposures. In these various vacuum chucks, the vacuum pump is regarded as the “holding actuator” that can be controllably placed in an actuated state and a non-actuated state such as by manipulating valves to connect and disconnect, respectively, application of vacuum. Generally, the holding actuator is in a non-actuated state as the vibration-inducing device is being actuated, to allow the vibration-inducing device efficiently to reduce the holding force.

Sonic coupling of the vibration-inducing device can be achieved in several possible ways. One way is by direct contact of the device with the object-mounting surface (or with another suitable location on the chuck), with the object, or with both. For example, the vibration-inducing device can be sonically coupled at least to the object-mounting surface via a structure supporting the object-mounting surface, such as (but not limited to) a Z-support. Another way of achieving sonic coupling (particularly with ultrasonic vibration) is across a gap in which actual physical contact is absent. Sonic coupling across a gap is useful for, e.g., preventing or inhibiting over-constraining or impeding the chuck or object.

Another aspect is directed to devices for holding a reticle. An embodiment of such a device comprises a reticle chuck having a reticle-holding surface on which a reticle is placed to hold the reticle. At least one ultrasonic transducer is sonically coupled to the reticle to excite, whenever the ultrasonic transducer is being energized, a vibrational mode in the reticle or reticle chuck, or both, the vibrational mode being sufficient to reduce an adhesion force holding the reticle to the reticle-holding surface.

A particularly advantageous configuration of the reticle chuck includes an opposing pair of membranes that hold respective portions of the reticle extending between the membranes. The membranes can be provided with respective vacuum chucks defined by the respective membranes in regions contacted by the reticle as the reticle is placed on the membranes. Vibrational modes, such as ultrasonic vibrational modes, are readily excited in membranes using transducer(s) that are sonically coupled to the membranes. The vibrational modes excited in the membranes desirably are not perfectly matched in the out-of-plane direction (z-direction). To such end, multiple transducers can be used, such as at least one respective transducer for, and sonically coupled to, each membrane.

The membranes can be provided with one or more additional supports, such as Z-supports, that can be used for, e.g., inhibiting excessive flexing of the membranes without over-constraining the membranes. These supports (e.g., Z-supports) can provide a way in which to achieve sonic coupling to the membranes, by connecting the Z-supports between respective transducers and respective locations on the respective membranes.

Yet another manner in which sonic coupling can be achieved is by placing the transducers on a structure that can be moved into sonic-coupling range relative to the reticle. For example, the ultrasonic transducers can be disposed on a loader arm by which the transducers are sonically coupled to the reticle as the loader arm is brought into sonic-coupling range with the reticle being held by the reticle chuck. The transducers on the loader arm can be energized at or before the moment the loader arm commences lifting of the reticle from the reticle chuck, at which moment the vacuum to the vacuum chucks is turned off. The transducers on the loader arm can be sonically coupled directly to (by contact with) the reticle or across respective gaps.

Another aspect is directed to devices for holding a reticle. An embodiment of such a device comprises a reticle stage, a reticle chuck mounted to the reticle stage, and at least one ultrasonic actuator sonically coupled to the reticle chuck, to the reticle, or to both. The reticle chuck defines (e.g., by multiple pins or the like) a mounting surface on which a reticle is placed to hold the reticle. The at least one ultrasonic actuator is controllably energized to excite a vibrational mode in the reticle being held by the reticle chuck. The vibrational mode is sufficient to reduce an adhesion force holding the reticle to the mounting surface. The reticle stage can comprise a movable stage body and first and second membranes extending substantially horizontally from respective portions of the stage body, wherein the reticle chuck comprises respective regions of the membranes. At least one respective ultrasonic actuator is sonically coupled to each membrane.

Yet another aspect is directed to methods for releasing a reticle from a reticle chuck. In an embodiment of such a method, with respect to a reticle being held by the reticle chuck, an ultrasonic vibrational mode is induced to the reticle chuck, to the reticle, or to both that is sufficient to reduce an adhesion force holding the reticle to the reticle chuck. Upon inducing the vibrational mode, the reticle is displaced relative to the reticle chuck. Induction of the ultrasonic vibrational mode is achieved by coupling an ultrasonic wave-train to the reticle chuck, to the reticle, or to both. This coupling can be direct or across a gap. The ultrasonic wave-train desirably is produced by an ultrasonic transducer as summarized above.

An exemplary embodiment of a reticle stage includes a stage body, a vacuum chuck, and at least one ultrasonic transducer. The stage body is movable in at least one direction relative to the base. The vacuum chuck is coupled to the stage body and includes a reticle-mounting surface that receives a corresponding region of a reticle. The at least one ultrasonic transducer is sonically coupled to the vacuum chuck, to the reticle, or to both to excite, when energized, an ultrasonic vibrational mode in the vacuum chuck, in the reticle, or in both that is sufficient to reduce an adhesion force holding the reticle to the vacuum chuck.

The foregoing and additional features and advantages of the invention will be more readily apparent from the following detailed description, which proceeds with reference to the accompanying drawings.

### BRIEF DESCRIPTION OF THE DRAWINGS

FIG. 1 is an elevational view showing relevant features of a reticle stage on which the reticle is supported by membranes and held by respective vacuum chucks associated with the membranes.

FIGS. 2(A) and 2(B) are an elevational section and plan view, respectively, of a reticle stage according to a first representative embodiment.

FIGS. 3(A) and 3(B) are an elevational section and plan view, respectively, of a reticle stage according to a second representative embodiment.

FIGS. 4(A) and 4(B) are an elevational section and plan view, respectively, of a reticle stage according to a third representative embodiment.

FIGS. 5(A) and 5(B) are an elevational section and plan view, respectively, of a reticle stage according to a fourth representative embodiment.

FIG. 6 is a schematic diagram of an embodiment of a lithographic exposure system 200 incorporating a reticle stage as described herein.

FIG. 7 is a flow-chart of an embodiment of a process for fabricating semiconductor devices and other micro-devices, using a system such as that of FIG. 6.

FIG. 8 is a flow-chart of a microlithography step in the process of FIG. 7.

### DETAILED DESCRIPTION

The invention is set forth below in the context of representative embodiments that are not intended to be limiting in any way.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

In this disclosure, the term “reticle” is used to denote a pattern-defining object (pattern master) used in microlithography and related techniques. Another term frequently used in microlithography to denote the pattern master is “mask,” and it will be understood that “reticle” as used herein encompasses reticles as defined above, masks, and other pattern masters used in microlithography. “Reticle” also is not limited to the context of projection microlithography. During use, a reticle normally is held on a reticle chuck, which in turn is mounted on a reticle stage that performs controlled positioning and movements of the reticle chuck. One technique for holding the reticle on the reticle chuck is vacuum-suction, examples of which are discussed in U.S. Pat. No. 6,480,260 and U.S. patent application Ser. No. 11/749,706, both incorporated herein by reference.

Relevant to this disclosure is a type of reticle chuck that comprises “membranes” that hold the reticle by vacuum suction. Each membrane is a thin, substantially planar member that is mounted to the reticle stage and extends horizontally (in an x-y plane) in a cantilever manner to provide support for the reticle. Usually, a laterally opposing pair of membranes is employed to hold the reticle as the reticle extends between the membranes. Each membrane has relatively high stiffness in the x-y (in-plane shear) directions but retains some flexibility in the z-direction (out-of-plane) to support the reticle, at least in part, and to allow the membranes to conform to the reticle. The cantilevered regions of the membranes that actually engage the reticle comprise respective “vacuum chucks” each with its respective reticle-holding surface. Each vacuum chuck includes pins, a combination of pins and lands, or analogous upwardly extending support-structures having respective upper surfaces that contact the under-surface of the reticle. The top surfaces of the pins (and lands, if used) collectively define the reticle-holding surface, which is substantially planar. Since the pins extend upwardly from the membrane, at least one “vacuum space” is defined between the membrane and the under-surface of the reticle. The vacuum space is controllably evacuated to apply vacuum-suction to the corresponding regions of the reticle and thus urge the reticle to adhere to the reticle-holding surface. The vacuum chucks engage respective certain peripheral regions (particularly regions near the left and right edges) of the reticle to allow exposure light to propagate to and from the reticle without obstruction. Reticles that are transmissive to the exposure wavelength are normally held on upward-facing vacuum chucks.

Evacuation of the vacuum spaces of the vacuum chucks as the reticle is resting on them produces a strong suction force holding the reticle to the reticle-holding surfaces of the vacuum chucks. In conventional systems, when the vacuum-suction is turned off, the reticle-holding force may not drop substantially to zero, as desired, but rather have a substantial residual magnitude that can interfere with or prevent removal of the reticle from the vacuum chucks. The residual reticle-holding force can have any of various causes such as, but not limited to, chemical interactions and/or physical interatomic attractions. Chemical interactions involve one or more of covalent bonds, electrostatic bonds, metallic bonds, and hydrogen bonds. Physical interatomic attractions involve, for example, van der Waals forces. Residual reticle-holding force can prevent the reticle from being removed from the reticle chuck without significant risk of damaging the reticle and/or the reticle chuck.

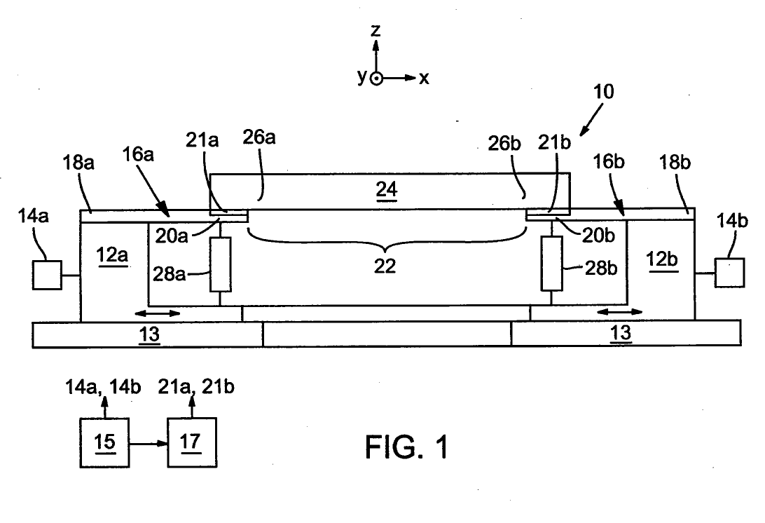

Reference is made now to FIG. 1, which depicts a reticle stage 10 comprising stage-body portions 12a, 12b. The stage-body portions 12a, 12b are movable relative to a stage base 13 by movers 14a, 14b, as generally known in the art. Mounted to the stage-body portions 12a, 12b are respective membranes 16a, 16b. Proximal portions 18a, 18b of the membranes 16a, 16b are mounted to the respective stage-body portion 12a, 12b, and distal portions 20a, 20b of the membranes extend part-way over a horizontal gap 22 between the stage-body portion 12a, 12b. The membranes 16a, 16b have distal portions 20a, 20b that include respective “vacuum chucks” 21a, 21b that hold the reticle 24. Specifically, left and right lateral zones 26a, 26b of the reticle 24 rest upon respective reticle-holding surfaces of the vacuum chucks 21a, 21b.

A controller 15 is connected to and controls actuation of the movers 14a, 14b. The controller 15 is also connected to a vacuum source 17 (typically comprising a vacuum pump). The vacuum source 17 selectively, under control of the controller 15, applies vacuum to the vacuum chucks 21a, 21b to hold the reticle 24 to the vacuum chucks. As held in this manner, the reticle 24 and membranes 16a, 16b collectively extend over the gap 22. Thus, the vacuum source 17, controlled by the controller 15, is an example of a “holding actuator” that holds the reticle 24 to the vacuum chucks.

The membranes 16a, 16b desirably have relatively high stiffness in the x-y directions (in-plane shear directions) and relatively low stiffness in the z-direction (out-of-plane direction) to facilitate conformance of the vacuum chucks 21a, 21b to respective regions of the reticle 24. Additional z-direction support for the membranes 16a, 16b is provided by Z-supports 28a, 28b extending downward to the respective stage-body portion 12a, 12b. The Z-supports 28a, 28b can include flexures. To provide a substantially kinematic mounting of the reticle 24, three Z-supports (e.g., two supports 28a supporting the left-hand membrane 16a, and one support 28b supporting the right-hand membrane 16b) can be used. Each Z-support provides one degree of constraint. Three Z-supports together provide substantially three degrees of constraint (z, θₓ, and θ_{y}). The two membranes 16a, 16b provide substantially three degrees of constraint (x, y, and θ_{z}). Together, the membranes 16a, 16b and Z-supports 28a, 28b substantially constrain the reticle 24 in the six rigid-body degrees of freedom.

The vacuum chuck 21a can be manufactured separately from the membrane 16a and assembled thereto, or alternatively can be formed integrally with the membrane. The respective materials of the membrane 16a, 21a can be similar or different. Exemplary materials from which to fabricate these components 16a, 21a are fused silica (amorphous quartz), crystalline silica, calcium fluoride, magnesium fluoride, barium fluoride, cordierite (magnesium aluminum silicate), aluminum oxide, ZERODUR® (a brand of glass ceramic from Schott AG, Germany), and any of various metals such as (but not limited to) invar and stainless steel. Particularly desirable materials have extremely low coefficients of thermal expansion, good inertness, and sufficient strength and flexibility for use.

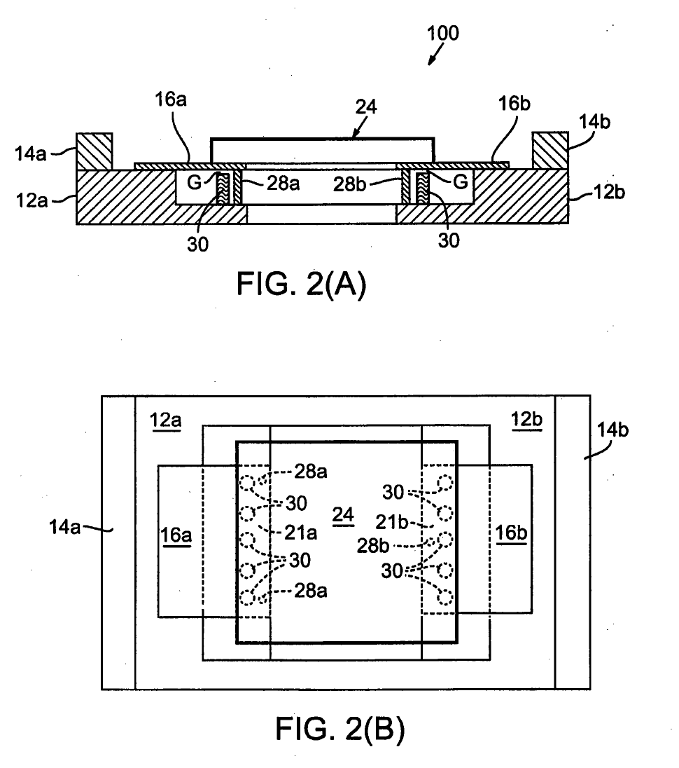

Reference is now made to FIGS. 2(A)-2(B), which depict a first representative embodiment of a reticle stage 100. Shown are the stage-body portions 12a, 12b, the membranes 16a, 16b, the reticle 24, and the Z-supports 28a, 28b. Note that three Z-supports are provided, one support 28b on the right beneath the vacuum chuck 21b, and two supports 28a on the left beneath the vacuum chuck 21a. Also shown are the stage movers 14a, 14b. Beneath each vacuum chuck 21a, 21b are respective ultrasonic transducers 30. Five transducers 30 are shown beneath each vacuum chuck, but this quantity is not intended to be limiting; depending upon the performance parameters of the particular transducers selected for use and upon parameters associated with the stage and membranes, the quantity of transducers can be “multiple” (two or more) or as few as one. In FIG. 2(A), the transducers 30 are mounted on respective stage-body portions 12a, 12b and extend upward toward the membranes 16a, 16b.

An “ultrasonic transducer” encompasses various devices that produce respective wave-trains of ultrasonic waves that can be directed to a desired location. These particular transducers 30 produce and direct ultrasonic waves upward from their top surfaces. In this embodiment, a gap G exists between the tops of the transducers 30 and the under-surface of the membranes 16a, 16b. The gaps G are required in this embodiment; if the transducers 30 contacted the under-surface of the membranes, the transducers would over-constrain the membranes and/or interfere with proper functioning of the Z-supports. The ultrasonic transducers 30 are “sonically coupled” to respective portions of the membranes 16a, 16b. Thus, the ultrasonic transducers 30 transmit ultrasonic energy across the gap G to excite one or more desired vibrational modes in the membranes 16a, 16b sufficient to release the reticle 24 from the vacuum chucks 21a, 21b without damaging the membranes or the reticle. Depending upon the number and specifications of the transducers 30 and upon other parameters, the gap G typically ranges from less than ten micrometers to approximately 100 micrometers or more, for example. (In other embodiments, sonic coupling is achieved by direct contact of the ultrasonic transducer with the respective portions of the membranes.)

Exemplary transducers 30 are PZT (lead zirconate titanate) piezoelectric transducers that are caused to vibrate at ultrasonic frequency when appropriately energized electrically. These transducers are commercially available in various sizes, including small sizes of less than 1 cm³. The transducers 30 are connected to respective driver circuits (not shown but understood in the art) and are controllably energized by the circuits whenever adhesion of the reticle 24 to the vacuum chucks 21a, 21b is to be stopped, avoided, or prevented, such as during the moment in which (or just before) the reticle is being lifted from the reticle stage. Energization of the transducers 30 can be coordinated with other events in a lithography system, such as movements of a robotic reticle handler.

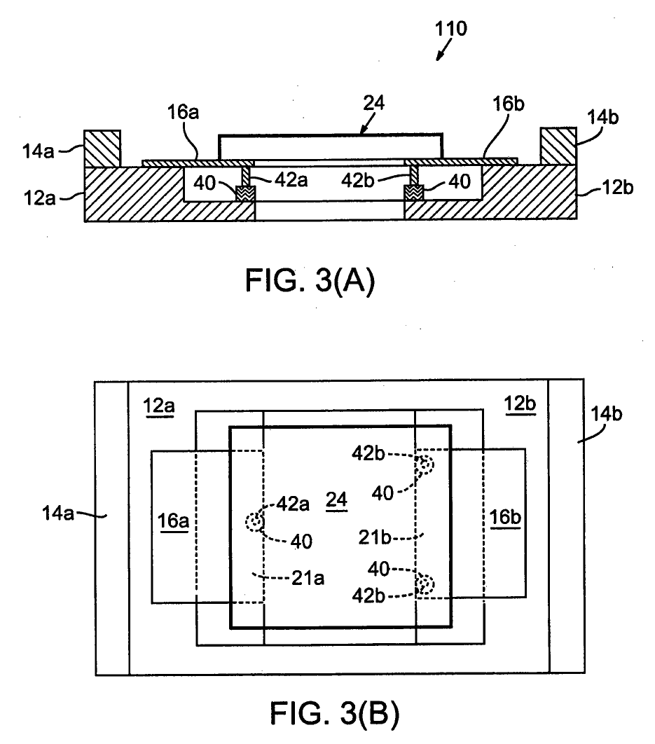

A second representative embodiment of a reticle stage 110 is shown in FIGS. 3(A)-3(B). Shown are the stage body 12a, 12b, the movers 14a, 14b, the membranes 16a, 16b, and the reticle 24. This embodiment includes three Z-supports 42a, 42b, wherein one Z-support 42a is situated beneath the left-hand vacuum chuck 21a, and two Z-supports are situated beneath the right-hand vacuum chuck 21b. This embodiment also includes three ultrasonic transducers 40, wherein a respective transducer is disposed beneath, and coupled to, each Z-support 42a, 42b between the Z-support and the stage body 12a, 12b. When energized the ultrasonic transducers 40 apply ultrasonic energy to the Z-supports to excite a desired vibrational mode in the membranes 16a, 16b (and hence in the reticle 24) sufficient to release the reticle 24 from the vacuum chucks 21a, 21b without damaging the membranes or the reticle.

In the embodiments described above, the ultrasonic transducer(s) are located on the reticle stage. However, this is not intended to be limiting. The typical circumstance in which temporary relief of reticle-holding force is advantageous is pick-up of a reticle from the reticle stage. The reticle is usually placed on and removed from the reticle stage using a reticle-handling robot. Reticles and reticle chucks are very delicate, and manual handling of reticles poses an excessive risk of damage or contamination of the reticle and/or reticle chuck. A robot operating properly eliminates or at least substantially reduces these risks. The reticle-handling robot typically includes one or more articulated, movable joints that terminate in a “loader arm” that actually lifts and carries the reticle and places the reticle. An exemplary loader arm picks up and holds the reticle by the four corners of the reticle.

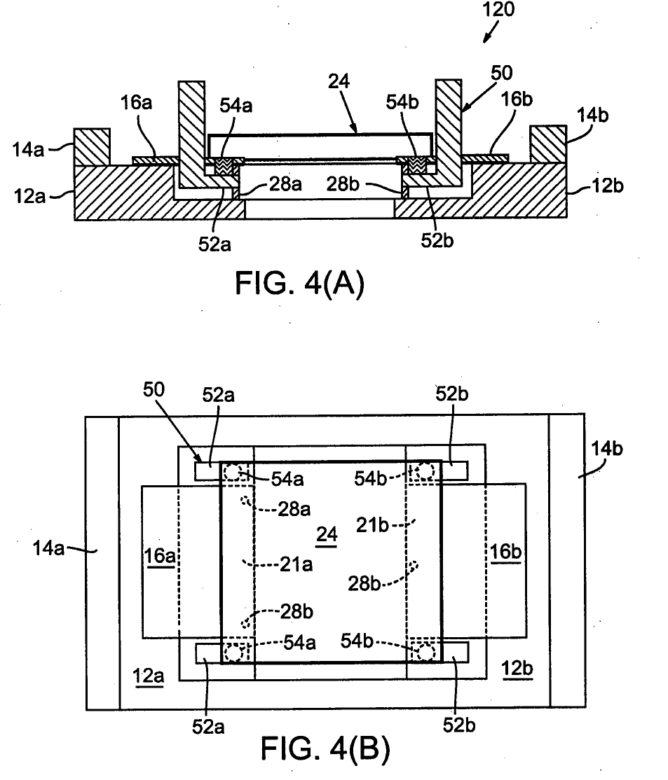

In certain embodiments the loader arm includes at least one ultrasonic transducer for reducing residual forces holding the reticle to the reticle chuck. This inclusion of ultrasonic transducer(s) on the loader arm can be an alternative to, or can be in addition to, including ultrasonic transducer(s) on the reticle stage. A representative embodiment 120 is shown in FIGS. 4(A)-4(B), in which ultrasonic transducers are located on the loader arm. Shown are the stage body 12a, 12b, the membranes 16a, 16b, the reticle 24, and the Z-supports 28a, 28b. In this embodiment, as in the first representative embodiment, three Z-supports are provided, one support 28b on the right beneath the vacuum chuck 21b, and two supports 28a on the left beneath the vacuum chuck 21a. Also shown are the stage movers 14a, 14b.

Also shown in FIGS. 4(A)-4(B) is a loader arm 50 including two left-hand claws 52a and two right-hand claws 52b. The loader arm 50 is positioned for loading the reticle 24 on the vacuum chucks 21a, 21b and for removing the reticle from the reticle chucks. Each claw 52a, 52b engages the under-surface of a respective corner of the reticle 24 in a manner allowing the loader arm to lift the reticle. In this embodiment each claw 52a, 52b comprises a respective ultrasonic transducer 54a, 54b extending upward to contact the under-surface of the respective corner of the reticle whenever the reticle 24 is being held by the loader arm 50. In preparation for lifting the reticle 24 from the vacuum chucks 21a, 21b, the claws 52a, 52b are pivoted or otherwise manipulated, as the loader arm is lowered relative to the reticle, to place the ultrasonic transducers 54a, 54b beneath respective corners of the reticle. At the moment of contact (or just before contact) of the top surfaces of the ultrasonic transducers 54a, 54b with the reticle 24, the transducers are energized briefly to excite a vibrational mode in the reticle sufficient to disrupt the residual force holding the reticle to the vacuum chucks. If the transducers 54a, 54b are energized just before contact with the reticle, then the ultrasonic energy produced by the transducers crosses gaps between the tops of the transducers and the under-surface of the reticle. If the transducers 54a, 54b are energized at the moment of contact, then of course the ultrasonic energy does not cross a gap. By robotic movement, the loading arm 50 lifts the reticle 24 from the vacuum chucks 21a, 21b, during which time the transducers 54a, 54b are not being energized.

As an alternative to using the ultrasonic transducers for making actual contact with the four corners of the reticle, the loading arm 50 can be provided with reticle-contact pads, pins, or the like that are distinct from (and slightly higher than) the transducers. In this alternative configuration, the transducers apply ultrasonic energy across a small gap to their respective corners of the reticle 24.

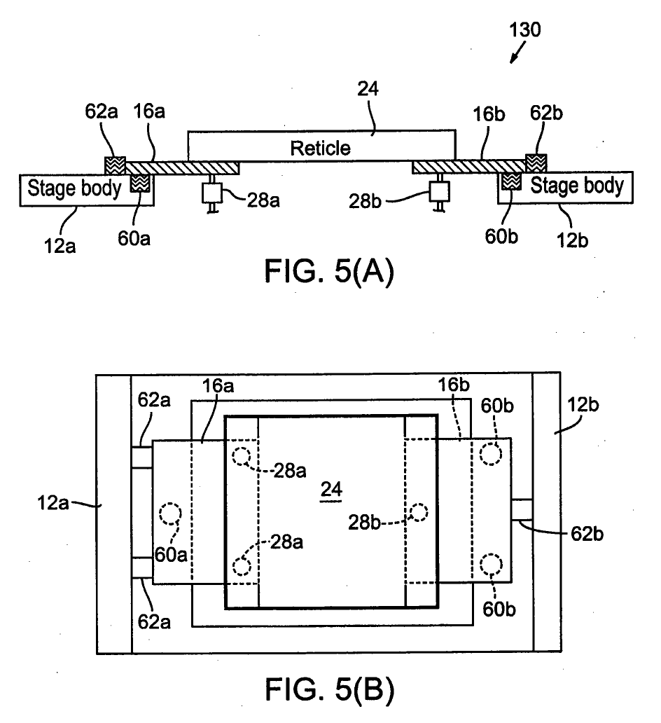

Referring now to FIGS. 5(A)-5(B), another representative embodiment is shown that includes one or more ultrasonic actuators situated in association with the membranes 16a, 16b. The figures depict two transducers 60a, 60b located beneath the respective membranes 16a, 16b. The figures also depict two transducers 62a, 62b flanking the respective membranes 16a, 16b. Various configurations according to this embodiment can have only the transducers 60a, 60b, only the transducers 62a, 62b, or all the transducers 60a, 60b, 62a, 62b, depending upon the particular vibrational mode that is desired.

The transducers 60a, 60b are recessed in the stage body 12a, 12b, respectively to allow the top surfaces of the transducers to contact the under-surface of the membranes 16a, 16b directly or, alternatively, to provide a gap between the top surfaces of the transducers and the under-surfaces of the membranes. The transducers 62a, 62b are mounted such that their respective energy-releasing surfaces face right and left, respectively, toward the respective membranes. The transducers can be directly contacting, as shown, with the respective membranes, or alternatively can be spaced from the respective membranes by respective gaps.

In the embodiment of FIGS. 5(A)-5(B) and other embodiments, the ultrasonic transducers, when energized, excite vibrational modes that produce localized stresses at respective interfaces of the reticle with the reticle chuck. The time period in which the transducers are energized can be very short, being only as long as necessary to facilitate separation of the reticle from the chuck. If (as is generally the case) the reticle and chuck are not perfectly matched in planarity and the like, there will be some inherent residual stresses that, during the transducer-energization period, help separate the reticle from the chuck. These stresses also prevent high-adhesion reattachment of the reticle to the chuck after the ultrasonic transducers are turned off.

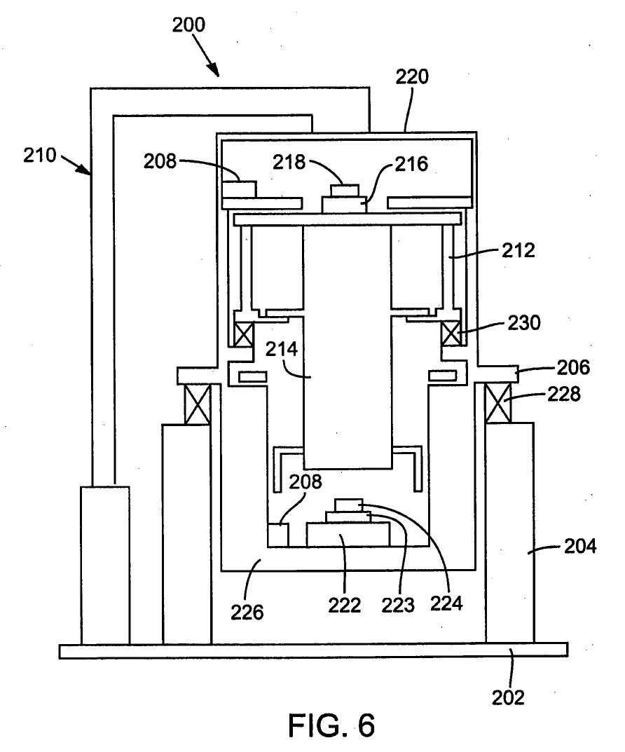

This invention provides a convenient way of enabling increased throughput in a microlithography system without degrading imaging or overlay performance of the microlithography system, using an ultrasonic actuator(s) and inherent pre-load (generated by, for example, vacuum-clamping the reticle to the chuck, wherein both have slightly different curvatures) to release a high-adhesion chucking force between the reticle and the chuck.

Whereas the various embodiments are described in the context of a reticle stage in which the reticle is held by vacuum suction, the principles described herein can also be applied to reducing residual reticle-chucking force in reticle stages in which the reticle is held by a force other than vacuum-suction, such as electrostatic force. Also, whereas the various embodiments are described in the context of reticle stages, the principles described herein can also be applied to a stage for holding something other than a reticle. FIG. 6 shows an embodiment of a lithographic exposure system 200 incorporating a reticle stage as described herein. The system 200 comprises a mounting base 202, a support frame 204, a base frame 206, a measurement system 208, a control system (not shown), an illumination-optical system 210, an optical frame 212, an optical system 214, a reticle stage 216 for holding and moving a reticle 218, an upper enclosure 220 surrounding the reticle stage 216, a substrate stage 222 for holding and moving a lithographic substrate (e.g., a semiconductor wafer), and a lower enclosure 226 surrounding the substrate stage 222. The substrate stage 222 is mounted on a substrate table 223.

The support frame 204 typically supports the base frame 206 above the mounting base 202 via a base vibration-isolation system 228. The base frame 206, in turn, supports (via an optical vibration-isolation system 230) the optical frame 212, the measurement system 208, the reticle stage 216, the upper enclosure 220, the optical system 214, the substrate stage 222, the substrate table 223, and the lower enclosure 226 about the base frame 206. The optical frame 212, in turn, supports the optical system 214 and the reticle stage 216 above the base frame 206 via the optical vibration-isolation system 230. As a result, the optical frame 212, the components supported thereby, and the base frame 206 are effectively attached in series, via the base vibration-isolation system 228, to the mounting base 202. The vibration-isolation systems 228, 230 are configured to damp and isolate vibrations between components of the exposure system 200; each of these systems comprises a vibration-damping device. The measurement system 208 monitors the positions of the stages 216, 222 relative to a reference such as the optical system 214 and outputs position data to a controller. The optical system 214 typically includes a lens assembly that projects and/or focuses light or a light beam from the illumination-optical system that passes through or reflects from the reticle 218. The reticle stage 216 includes one or more actuators (not shown) directed by the controller to position the reticle 218 precisely relative to the optical system 214. Similarly, the substrate stage 222 includes one or more actuators (not shown) to position the substrate 224 with the substrate table 223 precisely relative to the optical system 214. The reticle stage 216 also includes a vacuum-chuck, as described herein, for holding the reticle 218.

As will be appreciated by persons of ordinary skill in the relevant art, there are a number of different types of photolithographic systems. For example, the exposure system 200 can be a scanning-type photolithography system that progressively exposes a pattern from the reticle 218 onto a substrate 224 as the reticle and substrate are moved synchronously. The reticle 218 is moved perpendicularly to the optical axis of the optical system 214 by the reticle stage 216 as the substrate 224 is moved perpendicularly to the optical axis of the optical system by the substrate stage 222. Scanning of the reticle 218 and the substrate 224 occurs while the reticle 218 and the substrate 224 are moving synchronously.

Alternatively, the exposure system 200 can be a step-and-repeat type of photolithography system that exposes the reticle 218 while the reticle and substrate 224 are stationary. The substrate 224 is in a constant position relative to the reticle 218 and the optical system 214 during exposure of an individual field. Subsequently, between consecutive exposure steps, the substrate 224 is consecutively moved by the substrate stage 222 perpendicularly to the optical axis of the optical system 214 so that the next field of the substrate is brought into position relative to the optical system and the reticle 218 for exposure. Following this process, the pattern defined on the reticle 218 is sequentially exposed onto the fields of the substrate 224 so that the next field of the substrate is brought into position relative to the optical system 214 and the reticle.

The use of an exposure system 200 provided herein is not limited to a photolithography system as used for semiconductor-device manufacturing. The exposure system 200, for example, can be used as an LCD photolithography system that exposes the pattern of a liquid-crystal display (LCD) device onto a planar glass plate or as a photolithography system used for manufacturing a thin-film magnetic head. Further alternatively, the system 200 can be used to perform proximity photolithography. In proximity photolithography (used, e.g., for exposing mask patterns) a reticle or mask and the substrate are positioned very closely together axially and exposed without the use of a lens assembly therebetween. In general, the system 200 can be used in any of various other applications, including other semiconductor-processing applications, machine tools, cutting machines, and inspection machines, particular machinery that include reticle stages or analogous appliances.

The illumination source (of the illumination-optical system 210) can be, for example, a source of deep-UV, vacuum-UV, or extreme UV (soft X-ray) radiation. Examples of vacuum-UV sources are KrF excimer laser (248 nm), ArF excimer laser (193 nm), and F₂ excimer laser (157 nm). Alternatively, the illumination source can produce a charged particle beam such as an electron beam. Further alternatively, the illumination source can be a source of X-ray radiation. Example electron-beam sources are thermionic-emission types such as lanthanum hexaboride (LaB₆) sources and tantalum (Ta) sources, configured as an electron “gun.” Electron-beam systems can be based on projection lithography (using a mask or reticle) or direct-writing lithography (in which the pattern is directly formed on the substrate without having to use a mask).

With respect to the optical system 214, whenever a vacuum-UV source such as an excimer laser is used as the source, glassy materials such as quartz and fluorite that transmit deep-UV rays are preferably used. When an F₂ excimer laser or X-ray source is used, the optical system 214 should be either catadioptric or reflective (the reticle should also be reflective). When an electron-beam source is used, electron optics should be used such as electron lenses and deflectors. The optical path for electron beams or X-rays should be in a vacuum environment.

Also, with an exposure system that employs vacuum-UV radiation (wavelength of 200 nm or less), use of a catadioptric optical system can be considered. Examples of the catadioptric type of optical system are disclosed in Japan Patent Publication No. Hei 8-171054, corresponding to U.S. Pat. No. 5,668,672, and Japan Patent Publication No. Hei 10-020195, corresponding to U.S. Pat. No. 5,835,275. In these cases, the reflective optical device can be a catadioptric optical system incorporating a beam-splitter and a concave mirror. Japan Patent Publication No. Hei 8-334695 and its counterpart U.S. Pat. No. 5,689,377 and Japan Patent Publication No. Hei 10-003039 and its counterpart U.S. Pat. No. 5,892,117 use a reflective-refractive type of optical system incorporating a concave mirror, etc., but without a beam-splitter.

Further, in photolithography systems, if linear motors (see U.S. Pat. Nos. 5,623,853 and 5,528,118) are used in the substrate stage or reticle stage, the linear motors can be either air-levitation type, employing air bearings, or magnetic-levitation type, using Lorentz force or reactance force. The stage can move along a guide, or it can be guideless.

Alternatively, one of the stages can be driven by a planar motor, which drives the stage by electromagnetic force generated by a magnet unit, having two-dimensionally arranged magnets, and an armature-coil unit having two-dimensionally arranged coils in facing positions. With this type of driving system, either the magnet unit or the armature-coil unit is connected to the stage, and the other unit is mounted on the moving-plane side of the stage.

Movements of a stage, as described above, generate reaction forces that can affect performance of the photolithography system. Reaction forces generated by the substrate-stage motion can be mechanically released to the floor (ground) using a frame member as described in U.S. Pat. No. 5,528,118 and Japan Patent Publication No. Hei 8-166475. Reaction forces generated by the reticle-stage motion can be mechanically released to the floor (ground) using a frame member as described in U.S. Pat. No. 5,874,820 and Japan Patent Publication No. Hei 8-330224.

A photolithography system according to the above-described embodiments can be built by assembling various subsystems, including each element listed in the appended claims, in such a manner that prescribed mechanical accuracy, electrical accuracy, and optical accuracy are achieved and maintained. To obtain the various accuracies, prior to and following assembly every optical system is adjusted to achieve its specified optical accuracy. Similarly, mechanical and electrical systems are adjusted to achieve their respective specified mechanical and electrical accuracies. The process of assembling each subsystem into a photolithography system includes mechanical interfaces, electrical-circuit wiring connections, and air-pressure plumbing connections between each subsystem. There is also a process where each subsystem is assembled prior to assembling a photolithography system from the various subsystems. Once a photolithography system is assembled from the various subsystems, total system calibration and adjustment are performed to make sure that each accuracy specification is achieved and maintained in the complete photolithography system. It is desirable to manufacture an exposure system in a clean-room where the temperature, humidity, and particle load are controlled.

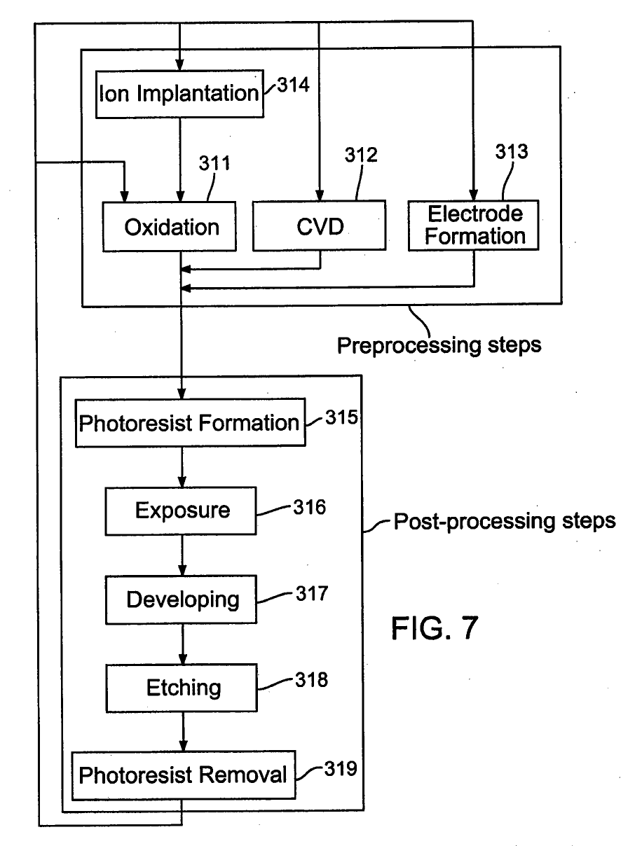

Semiconductor devices and other micro-devices can be fabricated using a system as described above, using a process shown generally in FIG. 7. In step 301 the function and performance characteristics of the micro-device are established and designed. In step 302 a mask (reticle) defining a pattern is designed according to the previous design step 301. In a parallel step 303 a substrate (e.g., semiconductor wafer) is made from an appropriate material (e.g., silicon). In step 304 the mask pattern designed in step 302 is exposed onto the substrate from step 303 using a photolithography system such as one of the systems described above. In step 305 the semiconductor device is assembled by executing a dicing step, a bonding step, and a packaging step. The completed device is inspected in step 306.

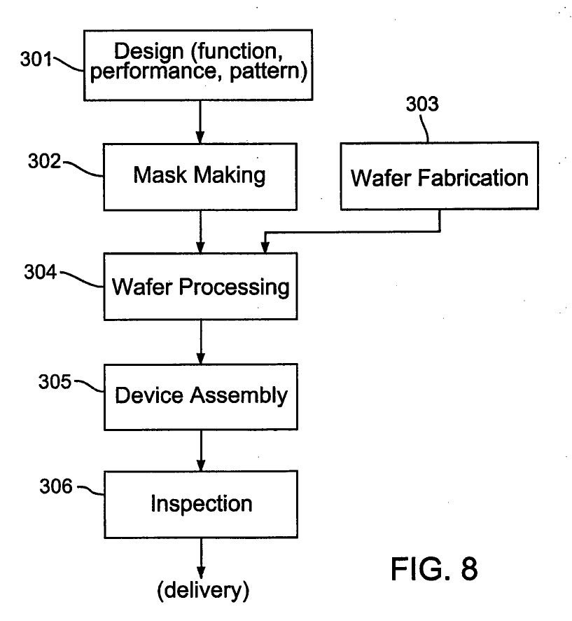

FIG. 8 depicts a flow-chart of an exemplary step 304 used in the case of fabricating semiconductor devices. In step 311 (oxidation) the substrate surface is oxidized. In step 312 (CVD) an insulation layer is formed on the substrate surface. In step 313 (electrode-formation) electrodes are formed on the substrate by vapor deposition or other suitable technique. In step 314 (ion-implantation) ions are implanted in the substrate as required. The steps 311-314 constitute “pre-processing” steps for substrates during substrate processing, and selection is made at each step according to processing requirements.

At each stage of substrate processing, upon completion of the pre-processing steps, the following post-processing steps are performed. In step 315 (photoresist formation) photoresist is applied to the substrate. In step 316 (exposure) the exposure system is used to transfer the circuit pattern of a mask or reticle to the substrate. In step 317 (developing) the exposed substrate is developed. In step 318 (etching) parts other than residual photoresist (i.e., exposed-material surfaces) are removed by etching. In step 319 (photoresist removal) unnecessary photoresist remaining after etching is removed. Multiple circuit patterns are formed by repetition of these pre-processing and post-processing steps.

As far as is permitted by the law, the disclosures in all references cited above are incorporated herein by reference.

Whereas the invention has been described in connection with representative embodiments, it will be understood that it is not limited to those embodiments. On the contrary, the invention is intended to encompass all modifications, alternatives, and equivalents as may be included within the spirit and scope of the invention, as defined by the appended claims.

What is claimed is:

1. A device for holding a substantially planar object, comprising:
a chuck comprising a substantially planar object-mounting surface that receives and holds a corresponding portion of the object;
a holding actuator coupled to the object-mounting surface, the holding actuator being selectively actuated and non-actuated and, when actuated, holding the corresponding portion of the object to the object-mounting surface with a holding force; and
at least one vibration-inducing device situated relative to and sonically coupled at least to the object-mounting surface, the vibration-inducing device being selectively energized and non-energized and, when energized, producing a vibrational mode at least in the object-mounting surface sufficient to reduce the holding force.

2. The device of claim 1, wherein the vibration-inducing device is also sonically coupled to the object to excite, when the transducer is energized, a vibrational mode in the object.

3. The device of claim 2, wherein:
the object is a reticle; and
the chuck is a vacuum chuck, of which the holding actuator comprises a vacuum source.

4. The device of claim 1, wherein:
the object is a reticle; and
the object-holding surface comprises a vacuum chuck, of which the holding actuator comprises a vacuum source.

5. The device of claim 1, wherein the holding actuator is in a non-actuated state whenever the vibration-inducing device is being energized.

6. The device of claim 1, wherein the vibration-inducing device is sonically coupled at least to the object-mounting surface by contact of the vibration-inducing device with the chuck.

7. The device of claim 1, wherein the vibration-inducing device is sonically coupled at least to the object-mounting surface via a structure supporting the object-mounting surface.

8. The device of claim 7, wherein the structure is a Z-support.

9. The device of claim 1, wherein the vibration-inducing device is sonically coupled at least to the object-mounting surface across a gap between the vibration-inducing device and the chuck.

10. The device of claim 1, wherein the vibration-inducing device comprises at least one ultrasonic transducer.

11. A device for holding a reticle, comprising:
a reticle chuck having a reticle-holding surface on which a reticle is placed to hold the reticle; and
at least one ultrasonic transducer sonically coupled to the reticle to excite, whenever the ultrasonic transducer is being energized, a vibrational mode in the reticle or reticle chuck, or both, the vibrational mode being sufficient to reduce an adhesion force holding the reticle to the reticle-holding surface.

12. The device of claim 11, wherein the reticle chuck comprises an opposing pair of membranes that hold respective portions of the reticle.

13. The device of claim 12, wherein the reticle chuck further comprises respective vacuum chucks defined by the respective membranes.

14. The device of claim 12, wherein the at least one respective ultrasonic transducer is sonically coupled to the respective membranes.

15. The device of claim 12, wherein sonic coupling is by direct contact of the at least one ultrasonic transducer with a respective membrane or with the reticle, or with both.

16. The device of claim 15, further comprising:
multiple ultrasonic transducers; and
at least one respective Z-support coupled to each membrane, the Z-support being coupled between a respective ultrasonic transducer and a respective location on the respective membrane, such that ultrasonic energy produced by each ultrasonic transducer is conducted to the respective membrane, to the reticle, or to both via the respective Z-support.

17. The device of claim 15, wherein the ultrasonic transducers are disposed on a loader arm by which the transducers are sonically coupled to the reticle as the loader arm is brought into sonic-coupling range with the reticle being held by the reticle chuck.

18. The device of claim 12, wherein sonic coupling is across respective gaps between the ultrasonic transducers and the respective membranes.

19. The device of claim 18, further comprising at least one respective Z-support coupled to each membrane, the Z-supports being coupled to respective locations on the respective membranes.

20. A device for holding a reticle, comprising:
a reticle stage;
a reticle chuck mounted to the reticle stage, the reticle chuck having a mounting surface on which a reticle is placed to hold the reticle; and
at least one ultrasonic actuator sonically coupled to the reticle chuck, the reticle, or both, the ultrasonic actuator being controllably energized to excite a vibrational mode in the reticle being held by the reticle chuck, the vibrational mode being sufficient to reduce an adhesion force holding the reticle to the mounting surface.

21. The device of claim 20, wherein the reticle stage comprises:
a movable stage body; and
first and second membranes extending substantially horizontally from respective portions of the stage body, wherein the reticle chuck comprises respective regions of the membranes; and
at least one respective ultrasonic actuator sonically coupled to each membrane.

22. The device of claim 21, wherein each ultrasonic actuator is sonically coupled across a gap between the ultrasonic actuator and membrane.

23. The device of claim 21, wherein each ultrasonic actuator is sonically coupled by direct contact of the ultrasonic actuators with respective membranes.

24. A method for releasing a reticle from a reticle chuck, comprising:
with respect to a reticle being held by the reticle chuck, inducing an ultrasonic vibrational mode to the reticle chuck, to the reticle, or to both that is sufficient to reduce an adhesion force holding the reticle to the reticle chuck; and
displacing the reticle relative to the reticle chuck.

25. The method of claim 24, wherein the ultrasonic vibrational mode is induced by coupling an ultrasonic wave-train to the reticle chuck, to the reticle, or to both.

26. The method of claim 25, wherein the coupling of the wave-train is by direct contact or across a gap.

27. The method of claim 26, wherein the coupling is direct and comprises:
providing at least one ultrasonic transducer on a loader arm;
moving the loader arm proximate, within sonic-coupling range, the reticle on the reticle chuck; and
energizing the at least one ultrasonic transducer.

28. The method of claim 27, wherein the loader arm is moved to contact the reticle on the reticle chuck with the loader arm such that the at least one ultrasonic transducer contacts the reticle.

29. The method of claim 25, wherein:
the ultrasonic wave-train is produced by an ultrasonic transducer; and
the coupling is by contact of the transducer with the reticle chuck, with the reticle, or with both.

30. The method of claim 29, wherein:
the ultrasonic wave-train is produced by an ultrasonic transducer; and
the coupling is across a gap between the transducer and the reticle, the reticle chuck, or with both.

31. The method of claim 30, wherein coupling across a gap comprises:
positioning at least one ultrasonic transducer proximate the reticle, the reticle chuck, or both, but separated therefrom by a gap; and
energizing the at least one ultrasonic transducer.

32. A reticle stage, comprising:
a base;
a stage body movable in at least one direction relative to the base;
a vacuum chuck coupled to the stage body, the vacuum chuck including a reticle-mounting surface that receives a corresponding region of a reticle; and
at least one ultrasonic transducer sonically coupled to the vacuum chuck, to the reticle, or to both to excite, when energized, an ultrasonic vibrational mode in the vacuum chuck, in the reticle, or in both that is sufficient to reduce an adhesion force holding the reticle to the vacuum chuck.

33. The reticle stage of claim 32, wherein the at least one ultrasonic transducer is mounted to the stage body.

34. The reticle stage of claim 32, wherein the at least one ultrasonic transducer is mounted to a movable device selectively brought into sonic-coupling proximity to the vacuum chuck, to the reticle, or to both.

35. The reticle stage of claim 34, wherein the movable device comprises a reticle loading arm.

36. A process system, comprising:
an optical system; and
a device for holding a substantially planar object relative to the optical system, the device comprising a chuck, a holding actuator, and a vibration-inducing device, the chuck comprising a substantially planar object-mounting surface that receives and holds a corresponding portion of the object, the holding actuator being coupled to the object-mounting surface and being selectively actuated and non-actuated such that, when actuated, the holding device holds the corresponding portion of the object to the object-mounting surface with a holding force, the at least one vibration-inducing device being situated relative to and sonically coupled at least to the object-mounting surface, the vibration-inducing device being selectively energized and non-energized and, when energized, producing a vibrational mode at least in the object-mounting surface sufficient to reduce the holding force.

37. The process system of claim 36, configured as a lithography system.

38. The process system of claim 37, wherein:
the object is a reticle; and
the chuck is mounted to a reticle stage.

39. A lithography system, comprising:
an optical system; and
a device for holding a reticle relative to the optical system, the device comprising a reticle chuck and at least one ultrasonic transducer, the reticle chuck having a reticle-holding surface on which a reticle is placed to hold the reticle, and the at least one ultrasonic transducer being sonically coupled to the reticle to excite, whenever the ultrasonic transducer is being energized, a vibrational mode in the reticle, in the reticle chuck, or in both, the vibrational mode being sufficient to reduce an adhesion force holding the reticle to the reticle-holding surface.

40. A lithography system, comprising:
an optical system; and
a reticle-holding device situated relative to the optical system, the reticle-holding device comprising a reticle stage, a reticle chuck mounted to the reticle stage, and at least one ultrasonic transducer, the reticle chuck having a mounting surface on which a reticle is placed to hold the reticle, and the at least one ultrasonic actuator being sonically coupled to the reticle chuck, to the reticle, or to both, the ultrasonic actuator being controllably energized to excite a vibrational mode in the reticle being held by the reticle chuck, the vibrational mode being sufficient to reduce an adhesion force holding the reticle to the mounting surface.

41. A lithography system, comprising:
an optical system and a reticle stage situated relative to the optical system, the reticle stage comprising a base, a stage body movable in at least one direction relative to the base, a vacuum chuck, and at least one ultrasonic transducer, the vacuum chuck being coupled to the stage body and including a reticle-mounting surface that receives a corresponding region of a reticle, and the at least one ultrasonic transducer being sonically coupled to the vacuum chuck, to the reticle, or to both to excite, when energized, an ultrasonic vibrational mode in the vacuum chuck, in the reticle, or in both that is sufficient to reduce an adhesion force holding the reticle to the vacuum chuck.

42. The system of claim 41, wherein the at least one ultrasonic transducer is mounted to a movable device selectively brought into sonic-coupling proximity to the vacuum chuck, to the reticle, or to both.

43. The reticle stage of claim 42, wherein the movable device comprises a reticle loading arm.
